(19) United States
(12) Patent Application Publication
(10) Pub. No.: US 2013/0114281 A1
(43) Pub. Date: May 9, 2013

(54) VEHICLE LAMP STRUCTURE

(71) Applicants: Byeong Ho Jeong, Hwaseong-si (KR); Jun Mo Ku, Hwaseong-si (KR); Se Wook Oh, Gunpo-si (KR)

(72) Inventors: Byeong Ho Jeong, Hwaseong-si (KR); Jun Mo Ku, Hwaseong-si (KR); Se Wook Oh, Gunpo-si (KR)

(73) Assignees: Kia Motors Corporation, Seoul (KR); Hyundai Motor Company, Seoul (KR)

(21) Appl. No.: 13/529,654

(22) Filed: Jun. 21, 2012

(30) Foreign Application Priority Data
Nov. 9, 2011 (KR) 10-2011-0116606

(51) Int. Cl. B60Q 1/30

(52) U.S. Cl. 362/516

(57) ABSTRACT

A vehicle lamp structure may include a reflector provided inside a housing and having a space portion formed therein to generate light reflection therein, a lens having one end that may be connected to the reflector in the housing and the other end that may be formed to project to an outside of the housing, and a light source mounted on an inner surface of the lens.

### CROSS-REFERENCE TO RELATED APPLICATION

The present application claims priority to Korean Patent Application No. 10-2011-0116606, filed on Nov. 9, 2011 in the Korean Intellectual Property Office, the entire contents of which is incorporated herein for all purposes by this reference.

### BACKGROUND OF THE INVENTION

1. Field of the Invention

The present invention relates to a vehicle lamp structure, and more particularly to a vehicle lamp structure that can implement constant surface light emission through application of a minimum number of light sources to the vehicle lamp structure.

2. Description of Related Art

In general, rear lamps are detachably mounted in the rear of a vehicle body, and enable drivers of front and rear vehicles to recognize the driving situation of the vehicle, to prevent a rear-end collision or the like.

In particular, the rear lamp mounted on the left or right side in the rear of the vehicle body is composed of one assembly in which a backup lamp, a brake lamp, and a direction indicator lamp are assembled together.

On the other hand, as the vehicle rear lamp, an LED (Light Emitting Diode), which has a long lifespan, expresses a high-quality image to outside, and has a superior visibility, has been increasingly used.

However, in the related art, since plural LEDs are applied according to a designed shape of the rear lamp, the manufacturing cost is increased. Further, as illustrated in FIG. 1, since a reflector is additionally provided to reflect light emitted through the plural LEDs in a lamp housing at various angles, the manufacturing cost is increased, and the number of components is increased to deteriorate the workability.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a vehicle lamp structure which can implement constant surface light emission through application of a minimum number of light sources to the vehicle lamp structure.

In one aspect of the present invention, a vehicle lamp structure may include a reflector provided inside a housing and having a space portion formed therein to generate light reflection therein, a lens having one end that is connected to the reflector in the housing and the other end that is formed to project to an outside of the housing, and a light source mounted on an inner surface of the lens.

The other end of the lens that projects to the outside of the housing may include an upper end portion and a lower end portion.

Inner surfaces of the upper end portion and the lower end portion face an inner surface of the reflector.

The vehicle lamp structure may further include a support portion formed between the upper end portion and the lower end portion, wherein the upper end portion and the lower end portion protrudes from the support portion, and wherein the light source is mounted on an inner surface of the support portion and aligned toward the reflector.

The housing may include a mounting hole through which the upper end portion and the lower end portion are mounted so that the other end of the lens projects to the outside of the housing.

The light source may include an LED.

As described above, according to the present invention, the number of light sources and reflectors can be minimized to reduce the manufacturing cost, and higher surface light emission can be achieved only with the minimum number of light sources to improve the merchantability.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a vehicle lamp structure in the related art.

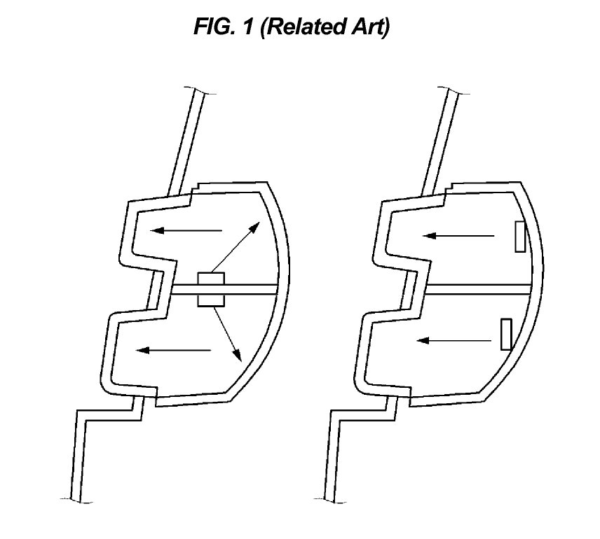

FIG. 2 is a view illustrating a vehicle lamp structure according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, a preferred embodiment of the present invention will be described with reference to the accompanying drawings.

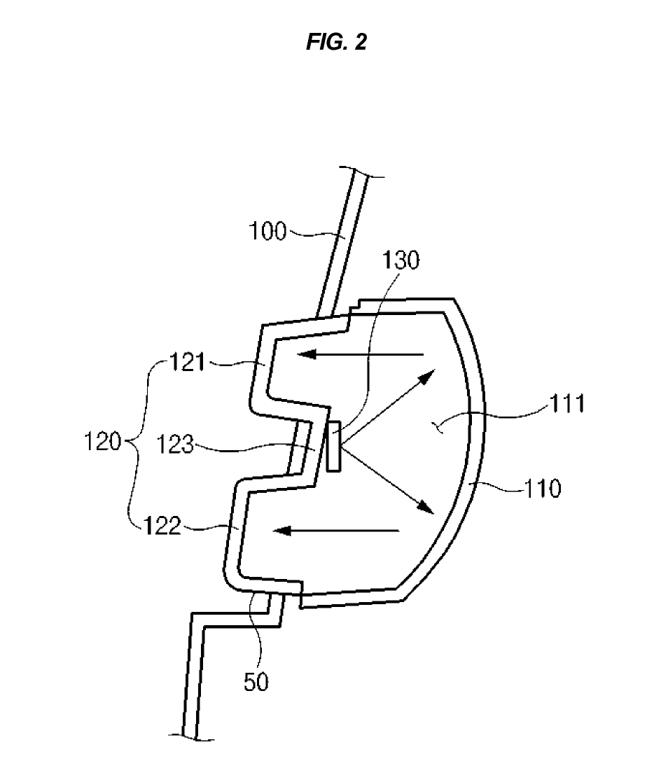

As illustrated in FIG. 2, a vehicle lamp structure according to an exemplary embodiment of the present invention includes a reflector 110 provided inside a housing 100, a lens 120 connected to the reflector 110, and a light source 130 mounted on an inner surface of the lens. The number of light sources and reflectors is minimized, and the surface light-emitting performance of the lamp is improved.

Respective constituent elements of a vehicle lamp structure according to an exemplary embodiment of the present invention will now be described in detail with reference to the accompanying drawing.

First, as illustrated in FIG. 2, the vehicle lamp structure according to an exemplary embodiment of the present invention basically includes the reflector 110 provided inside the housing 100, the lens 120 connected to the reflector 110 and projecting to the outside of the housing 100, and the light source 130 mounted on the inside of the lens 120.

The housing 100 forms an external shape of the vehicle lamp. In the drawing of the present invention, only a portion of the housing 100 is illustrated.

In the housing 100, the light source 130 emitting light and the reflector 110 reflecting the light emitted from the light source 130 are provided, and on the outer surface of the housing 100, the lens 120 enabling the light reflected by the reflector 110 to be irradiated to the outside is provided.

In an exemplary embodiment of the present invention, the housing 100 may include a mounting hole 50 and the lens 120 is coupled to the mounting hole 50.

The reflector 110 is provided inside the housing 100, and has a space portion 111 formed therein so that total reflection occurs inside the reflector 110.

The lens 120 is to irradiate the light in the housing 100 to the outside. On end of the lens 120 is connected to the reflector 110, and the other end thereof is formed to project to the outside of the housing 100.

On the other hand, the outer portion of the lens 120 that projects to the outside of the housing 100 is divided into an upper end portion 121 and a lower end portion 122, and the light emitted from the inside of the housing 100 is divided through the upper end portion 121 and the lower end portion 122 of the lens 120 to be irradiated to the outside.

The lens 120 may include a support portion 123 formed between the upper end portion 121 and the lower end portion 122. The support portion 123 may be mounted on the housing 100 when the upper end portion 121 and the lower end portion 122 are coupled to the mounting hole 50 of the housing 100.

The light source 130 is mounted on the inner surface of the support portion 123, and the light emitted from the light source 130 in the housing 100 is reflected by the reflector 110 and is irradiated to the outside of the lens 120.

Here, it is preferable that the light source 130 includes an LED (Light Emitting Diode).

As described above, according to an exemplary embodiment of the present invention, since the lens 120 that projects to the outside of the housing 100 is divided into the upper end portion 121 and the lower end portion 122 to form two light-emitting surfaces and the light source 130 is provided on the inner surface of the lens 120, a better surface light-emitting effect can be obtained even with only one light source in comparison to a case where a plurality of light sources are installed, and thus the light-emitting design of the lamp can be improved.

As described above, according to an exemplary embodiment of the present invention, since the vehicle lamp structure includes the reflector provided inside the housing and having the space portion formed therein to generate the total reflection therein, the lens having one end that is connected to the reflector and the other end that is formed to project to the outside of the housing, and the light source mounted on the inner surface of the lens, the number of light sources and reflectors can be minimized, and higher surface light emission can be achieved only with the minimum number of light sources to improve the merchantability.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A vehicle lamp structure comprising:
a reflector provided inside a housing and having a space portion formed therein to generate light reflection therein;
a lens having one end that is connected to the reflector in the housing and the other end that is formed to project to an outside of the housing; and
a light source mounted on an inner surface of the lens.

2. The vehicle lamp structure according to claim 1, wherein the other end of the lens that projects to the outside of the housing includes an upper end portion and a lower end portion.

3. The vehicle lamp structure according to claim 2, wherein inner surfaces of the upper end portion and the lower end portion face an inner surface of the reflector.

4. The vehicle lamp structure according to claim 2, further including a support portion formed between the upper end portion and the lower end portion,
wherein the upper end portion and the lower end portion protrudes from the support portion; and
wherein the light source is mounted on an inner surface of the support portion and aligned toward the reflector.

5. The vehicle lamp structure according to claim 4, wherein the housing includes a mounting hole through which the upper end portion and the lower end portion are mounted so that the other end of the lens projects to the outside of the housing.

6. The vehicle lamp structure according to claim 1, wherein the light source includes an LED.
